(19) United States
(12) Patent Application Publication
(10) Pub. No.: US 2003/0109307 A1
(43) Pub. Date: Jun. 12, 2003

(54) Method and apparatus for communicating with a player of a networked gaming device

(76) Inventor: Scott A. Boyd, Las Vegas, NV (US)

Correspondence Address: MARGER JOHNSON & McCOLLOM, P.C., 1030 S.W. Morrison Street, Portland, OR, 97205, US

(21) Appl. No.: 10/170,238

(22) Filed: Jun. 11, 2002

Related U.S. Application Data
(60) Provisional application No. 60/297,490, filed on Jun. 11, 2001.

(51) Int. Cl. A63F 13/00

(52) U.S. Cl. 463/41

(57) ABSTRACT

This embodiment of a method and apparatus for communicating with a player of a networked gaming device incorporates a touch screen display into an electronic slot machine. The display facilitates player interaction with the slot machine network to enable cashless gaming, player tracking, bonus, and secondary game features.

### BACKGROUND

1. Field of the Invention

This patent application claims priority from U.S. Provisional Patent Application Serial No. 60/297,490, filed Jun. 11, 2001, which is hereby incorporated by reference for all purposes.

The present invention relates to a player interface associated with an electronic gaming device and, more particularly, to such an interface that includes a display and an input device to provide interactive communication with the player.

2. Background of the Invention

Incorporating casino slot machines into a computer network is well known. Early in the deployment of such networks, preexisting slot machines were retrofitted by installing a communications board that included a processor, memory and other components that facilitated communications between the electronic slot machine and the network. When so configured, transactions at one of slot machines could be communicated via the board onto the network and from there to a computer that stored the transactions for later analysis and verification. Conversely, the network computer can issue commands onto the network that are addressed to a particular machine or a group of machines. The communications board receives the command and communicates with the slot machine to effect, for example, payment of a bonus over and above the pay table in the slot machine as described in U.S. Pat. No. 5,655,961, which is owned by the assignee of the present application and which is incorporated herein by reference for all purposes.

In addition to the communications board, it is well known to install a card reader, a display, and a keypad at each slot machine to facilitate player tracking, as it is referred to in the industry. In a conventional player-tracking system, each player is assigned a card and an associated account, which is maintained on a network computer. Before playing one of the slot machines, the player inserts his or her card to cause points proportionate to play to accrue in his or her account. The points are then redeemable by the player for additional play, dinners, merchandise, or the like. In addition, the card, keypad and display, which is typically a vacuum fluorescent display or a small-character LCD display, can be used to permit a player to access a cashless play account or to access credits that are either complimentary or awarded to the player during the course of his or her play.

The design, construction and operation of networked slot machines, including the card reader, the keypad and the display, as mentioned above, is described in detail in the '961 patent. Another embodiment is also described in U.S. Pat. No. 6,319,125 for a Method and Apparatus for Promoting Play on a Network of Gaming Devices, which is also assigned to the assignee of the present application and which is also incorporated herein by reference for all purposes.

In addition to player-tracking functions, cashless play and associated functions can be implemented using the system of FIG. 1 as described in U.S. patent application Ser. No. 09/694,065, which is assigned to the assignee of the present application and which is incorporated herein by reference for all purposes. In addition, conversion of player-tracking points into playable credit can also be implemented using the system of FIG. 1 as described in U.S. patent application Ser. No. 09/134,598, which is also assigned to the assignee of the present application and which is also incorporated herein by reference for all purposes.

### BRIEF DESCRIPTION OF THE DRAWINGS

FIG. 1 is a partial view of a slot machine, shown in dashed lines, that is part of an implementation of the present embodiment of the invention, including an interactive display screen and card reader, shown in solid lines.

FIG. 2 is an enlarged partial view of the display of FIG. 1.

FIG. 3 is a right-side view of the display of FIG. 2.

FIG. 4 is a bottom view of the view of FIG. 2.

FIG. 5 is a schematic view of the slot machine display and card reader of FIG. 1 depicting the manner in which circuitry associated with each is connected to a network of similar slot machines incorporating displays and card readers.

FIG. 6 is a schematic view of the display and related components of FIG. 5.

FIG. 7 is a view of the display and card reader on the slot machine of FIG. 1, including an image depicted on the display screen.

FIGS. 8-26 are enlarged views of the display screen depicted in FIG. 7 with images displayed thereon as described in the following detailed description.

### DETAILED DESCRIPTION OF THE PREFERRED EMBODIMENTS

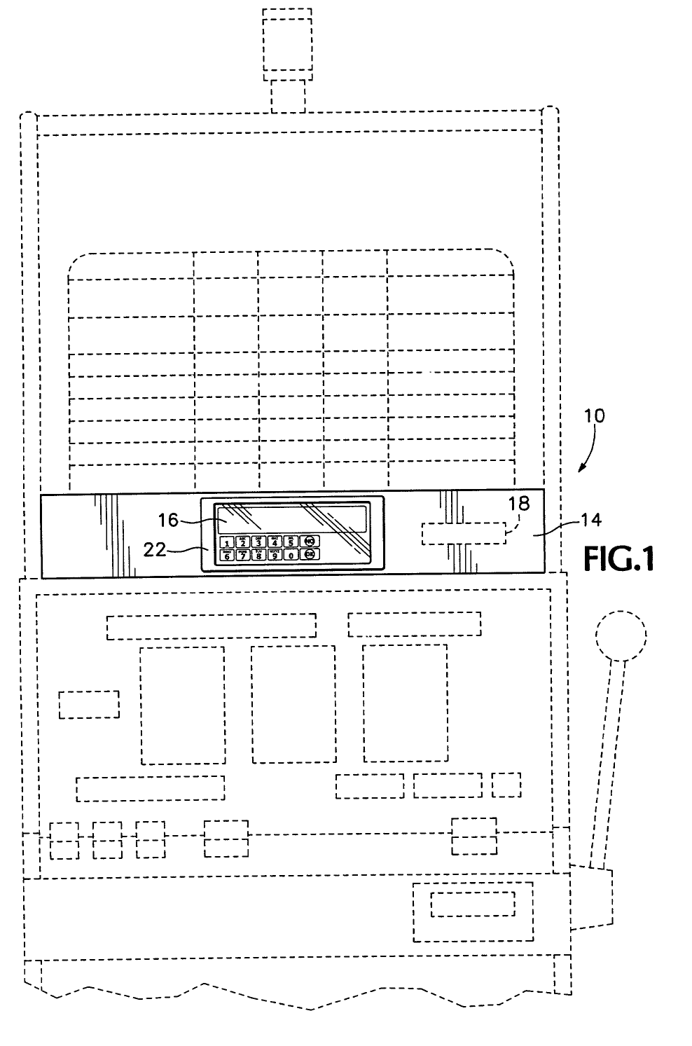

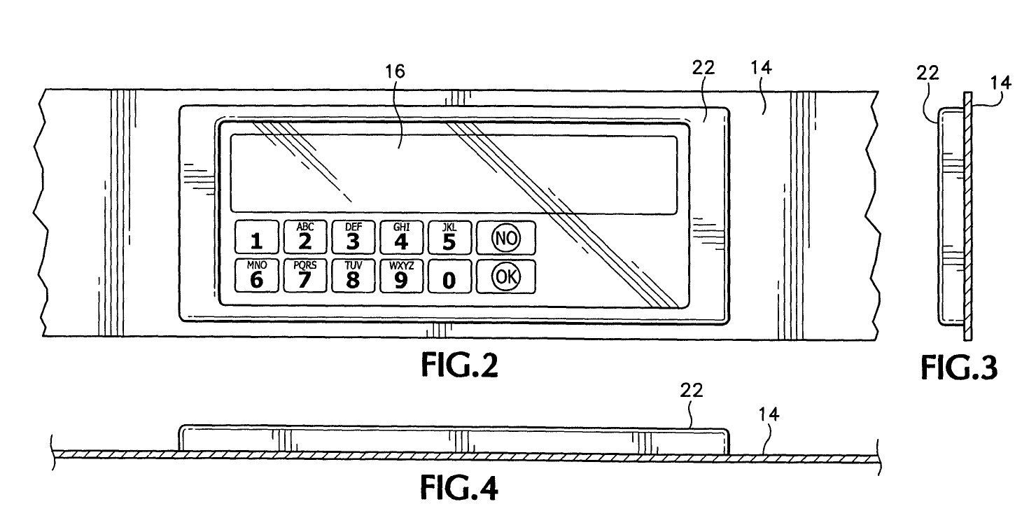

Turning first to FIGS. 1-4, indicated generally at 10 is the upper portion of a slot machine. The slot machine is a commercially available electronic gaming device that has been modified as described herein.

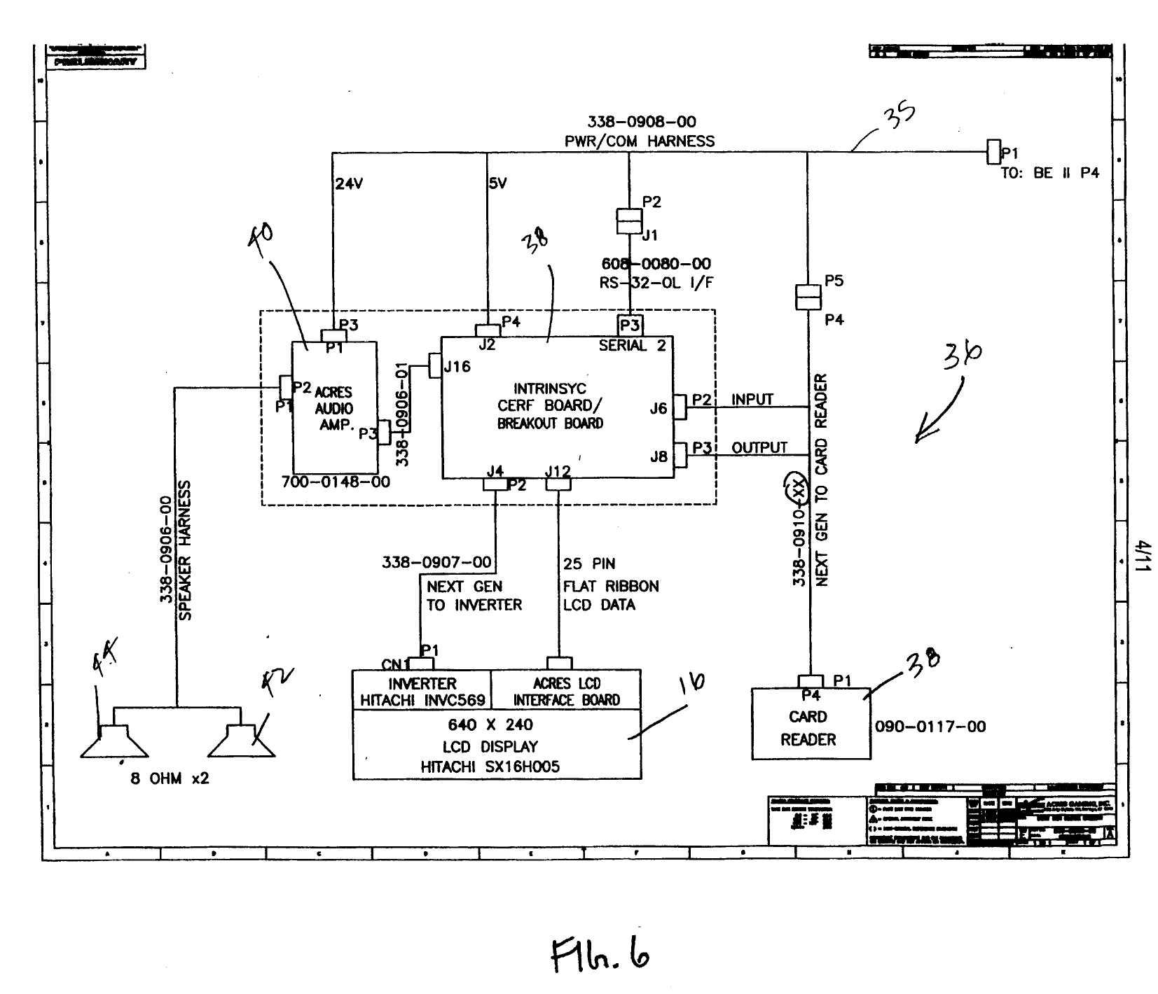

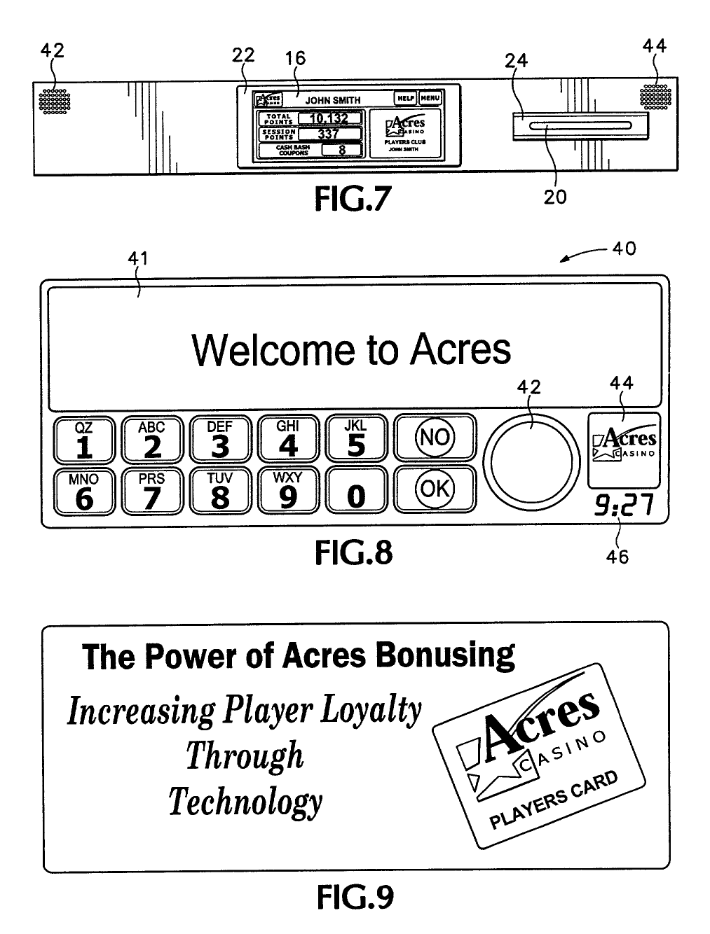

One aspect of the modifications to slot machine 10 includes addition of a bracket 14 mounted on the front of the slot machine. The bracket includes two openings, the first containing a 640×240 touch-panel liquid crystal display (“LCD”) 16. In the present embodiment of the invention, LCD 16 comprises a Hitachi SX16H005-AZA LCD. The second opening 18, in FIG. 1, contains a card reader having a slot 20 (visible in FIG. 7), into which a player's card is received as is known in the art. As shown in FIG. 7, both LCD 16 and slot 20 are framed by respective bezels 22, 24. Card reader bezel 24 and slot 20 are not shown in FIG. 1.

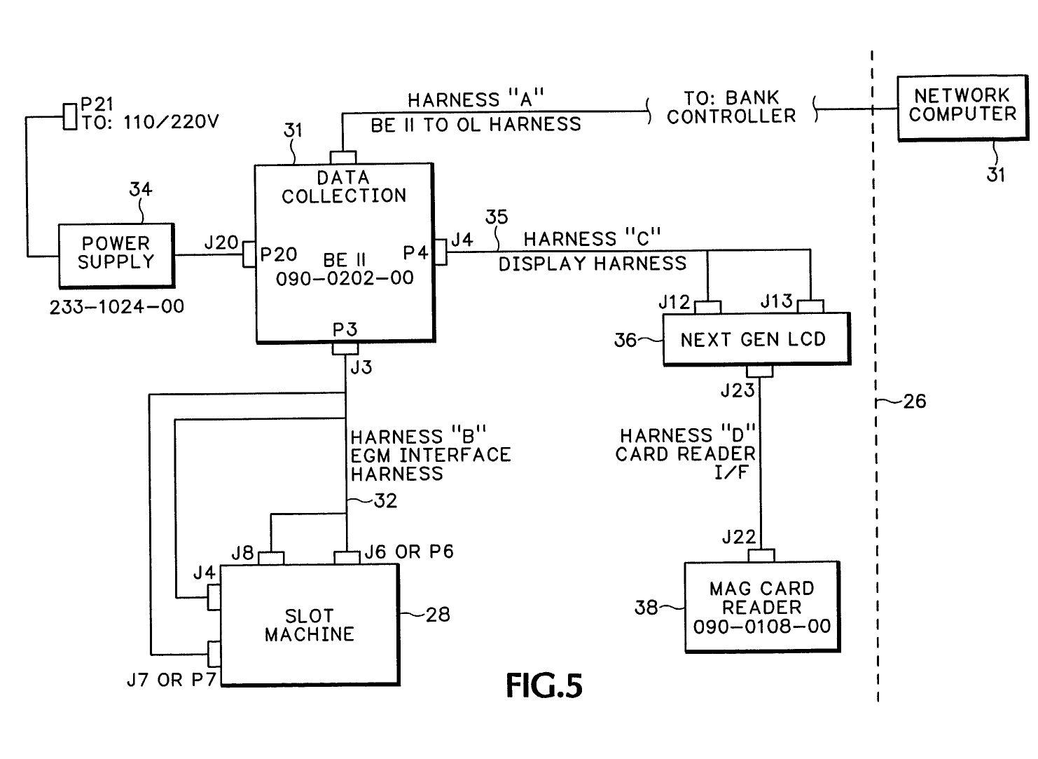

Turning now to FIG. 5, the schematic components depicted therein on the left side of dashed line 26 are all contained within the cabinet that houses slot machine 10 in FIG. 1. Slot machine electronics 28 is part of the original slot machine structure provided by the slotmachine manufacturer. The additional components on the left side of line 26, however, are all added to implement the invention in association with electronics 26 and the network.

The components within the slot machine, i.e., on the left side of line 26, are connected to a computer network, along with numerous additional slot machines having the related structure depicted in FIG. 5. The network is illustrated as a computer 30 on the right side of dashed line 28. Networked slot machines are known in the art and are depicted in '961 and '125 patents. The network includes databases for storing slot machine transactions and player tracking data, servers for implementing system games and bonuses, configuration work stations for configuring the system games and bonuses, and a Content Manager, which is a program implemented on a network computer that permits an operator of the system, typically a casino, to customize and configure images that appear on display 16.

The slot-machine electronics 28 are connected to a system-machine interface board 31 via a wiring harness 32. Board 31 provides communications between the slot machine electronics 28 and network 30 in a manner that is described in the '961 and '125 patents. A power supply 34 provides power to board 31. A wiring harness 35 connects board 31 with the display and associated electronics 36. Another harness connects board 31 to the network including computer 30. The power supply also supplies power to electronics 36 and to a card reader 38. The card reader is behind bezel 24 in FIG. 7 and includes slot 20.

Turning now to FIG. 6, additional details of the display and associated electronics 36 in FIG. 5 are depicted schematically.

A dedicated computer 38 includes an LCD controller and electronics for enabling VGA touch panel images and sound for LCD 16. In the present embodiment of the invention, computer 38 is a commercially available processor board manufactured by Intrinsyc. It includes an Intel ARM processor and a Windows CE operating system. Computer 38 also includes nonvolatile memory for storing images and sounds that are utilized as described hereinafter. An amplifier 40 provides sound signals to speakers 42, 44, which are partially visible in FIG. 7.

In the present embodiment of the invention, the networked slot machines are initially configured using the Content Manager, which—in the present embodiment of the invention—runs on the same network PC platform as a configuration work station, which enables files to be downloaded to the system-machine interface board, like board 31, associated with each slot machine. Once the screens and features of individual screens are selected at the Content Manager, an initialization file is created that identifies which MMC files and features have been selected. The configuration workstation can then be used to download the initialization file and associated MMC files to all the machines, to groups of machines, or even to a single selected machine. These initialization files and associated MMC files are stored in nonvolatile memory in electronics 36. All parameters associated with the audio content and with display 16 can be configured in this manner.

In operation of the prior art VFD, System Tokens—such as a player's name or accrued points—are embedded in a slot-machine message comprising otherwise constant text strings that appear on the VFD. For example in the message Hello Richard, Hello comprises a constant text string and Richard comprises the System Token, here, the player name associated with the player card in use.

In the present invention, an MMC Token is embedded in the prior art VFD message, which may includes System Tokens, that is transmitted to board 31 by the network and from there to board 38. As a result, if the message is received by a slot machine with a VFD, the usual VFD message is displayed. If it is received by a slot machine with an LCD, the MMC message identified by the MMC Token is called from storage in electronics 38 and run, incorporating any System Tokens as specified in the network message. But when a VFD message that does not include an MMC Token is received at an LCD machine, the FIG. 8 emulation screen appears bearing the VFD message in the upper half, and emulating a prior art keypad, which is associated with the VFD in prior art machines. This feature permits gradual introduction of LCD machines on a network and gradual introduction of MMC messages to any LCD machines that are on the network. Multimedia content can thus be downloaded on the gaming-machine network and displayed on the LCD as described above.

In FIG. 8, display 16 is shown with an image that appears when the system emulates a prior art vacuum florescent display (VFD), like that disclosed in the '961 and '125 patents. The touch screen display image includes a keypad 40, a message screen 41, a bonus button 42, a casino logo 44, and a time display 46. Unless it is otherwise clear from the context, use of the term “button” herein refers to an image of a button on the touch screen, which enables a player to interact with the network by touching screen 16 over the button image. The casino operator has the option, implemented via the Content Manager, of displaying various features such as the bonus button and the system time, dependent upon the operator's preference. Emulation mode is advantageous in two situations. First, if the touch screen display has not been configured, or configured incorrectly, the image of FIG. 8 appears. Second, when prior art systems are retrofitted to include some slot machines that incorporate the touch screen LCD of the present invention and others that incorporate the prior art VFD, there may be some network display messages that are not implemented with the multimedia content (“MMC”) used by LCD 16. If so, the system defaults to VFD emulation mode, in which VFD messages are displayed on message screen 41, while the player enters commands using keypad 40 and bonus button 42. In this mode, touch keypad 40 and the message panel 41 emulate the behavior of the prior art VFD and keypad, respectively.

In another embodiment of the invention, a separate network, i.e., a different network from the one computer 31 is on, is connected to board 38. This separate network provides MMC to board 38 for displaying images or playing audio. Such a network could be used to deliver real-time multimedia content to the display 16 and speakers 42, 44. In addition, this network is used to deliver real-time video, either broadcast or closed circuit, to the display while play is ongoing. The keypad image on the touch screen display is used by the player to select a broadcast or closed-circuit channel. This configuration could permit a player to watch, e.g., a sporting event or other show while gaming.

FIG. 9 depicts an example of display 16 in idle-attract mode, i.e., when there is no player card inserted in slot 20. When there is no card, the system displays up to 32 full size screens in a repeating sequence. Using a computer and keyboard on the network, the operator can control the duration, time of day, and sound associated with the idle-attract mode.

Turning to FIG. 10, the display is shown as it appears after a player enters his or her card into slot 20 of the card reader. This display includes a title, Pin Entry, PIN being an acronym for Personal Identification Number, a number that is stored on the network in association with the player's account. Also included is a casino logo 48, in the present embodiment of the invention, the logo of the assignee being utilized for illustrative purposes. In the upper right-hand corner of the display are an Exit button 50 and a Help button 52. Exit button 50 permits the player to cancel current operations or to move back to the previous screen. In FIG. 10, if Exit button 50 is pressed, the system resumes the idle-attract mode of FIG. 9. Pressing Help button 52 retrieves up to 8 screens of help information (e.g., as shown in FIG. 14) that can be configured on the Content Manager.

The display of FIG. 10 also includes a touch keypad 54, a touch Enter button 56, a touch Cancel button 58, and a PIN entry field 60, which displays an asterisk each time a digit from the player's PIN is entered on keypad 54.

In operation, when a player enters his or her card into slot 20, the FIG. 10 image appears on display 16. The player enters the PIN associated with the player card by pressing the digits on keypad 54 and hitting Enter button 56. The Content Manager can be used to change the number of PIN digits required. There is also an auto enter feature that can be implemented at the Content Manager that sends the PIN to board 31 without waiting for the player to push the Enter button.

If, however, a player's card format cannot be recognized when it is inserted into slot 20, the display of FIG. 11 appears.

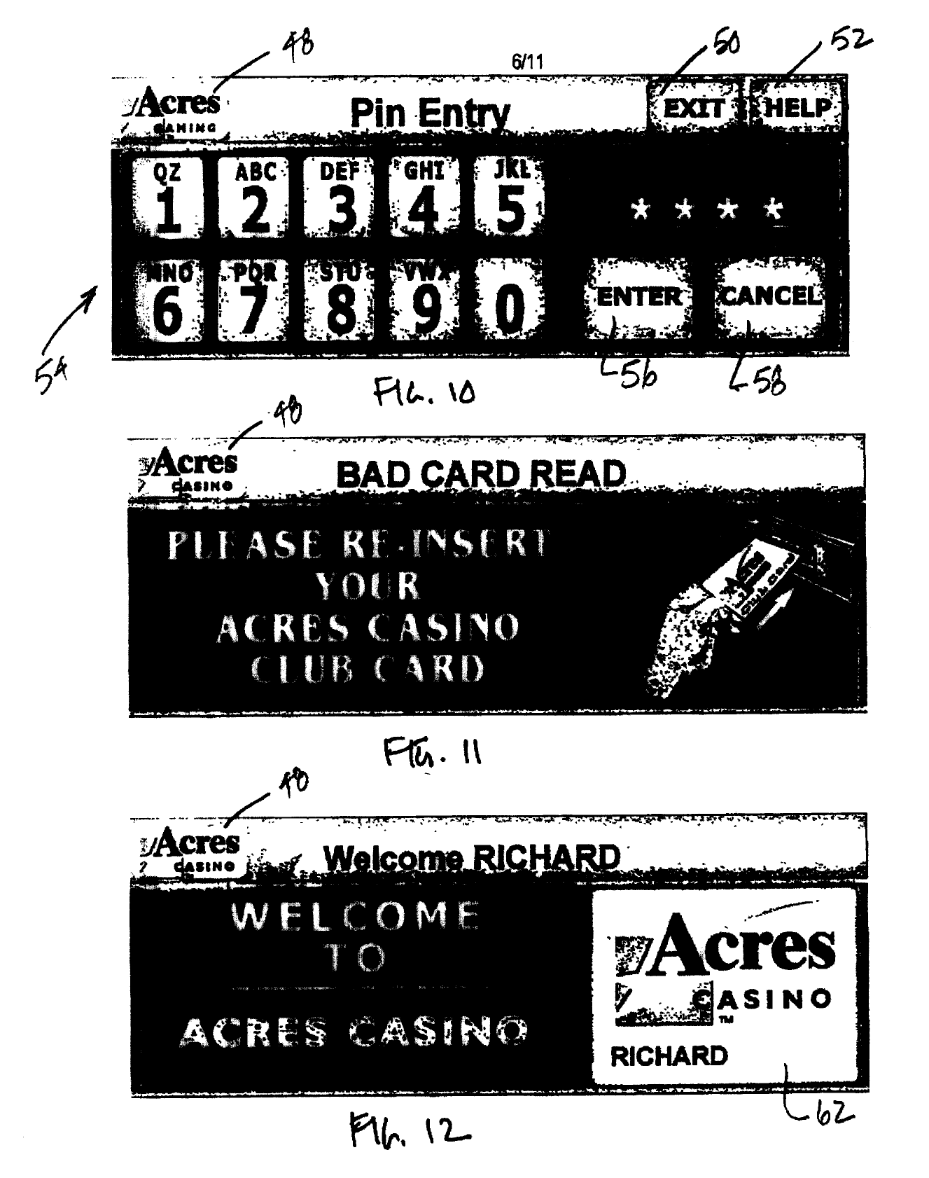

When the format is recognized and the PIN is transmitted to board 31, the card information and PIN stored on a network computer is compared with those entered at slot machine 10. If there is a match, the image of FIG. 12 is displayed. The FIG. 12 image includes a personalized welcome, using the name associated with the player account, and a replica of the player card 62. Speakers 42, 44, also play accompanying audio. The system operator can control the colors on the image of FIG. 12 via the Content Manager. The screen will persist on the display for up to 30 seconds, a time that can also be configured by the operator on the Content Manager.

In addition, the system is configured to require the PIN as described above each time the player is either requesting personal information, such as cash or point balances, or issuing commands to effect account changes, such as transferring cash to or from a slot machine. This provides increased account security, including protecting the player's account in the event that he or she leaves the game without withdrawing the card.

After the welcome screen of FIG. 12, a session screen, shown in FIG. 13 is displayed. A Menu button 53 calls the image of FIG. 17 as later discussed in more detail. The session image includes the player's name at the top and displays and updates the player's total player tracking points (Total Points), points accrued during the current session (Session Points), and additional coins to play necessary to generate additional points (Coins to Go). The Coins to Go display can be enabled or not depending upon the operator's preference, using the Content Manager. The image of FIG. 13 persists until the player takes some action or the system interrupts the session screen with a higher priority display. FIG. 14 depicts another image of the FIG. 13 session screen after Help button 52 is touched. This displays a stored help screen relating to—in this case—the session screen. The help displayed is in the context of the current screen upon which Help button 52 is touched, i.e., the help relates to the display on the current screen.

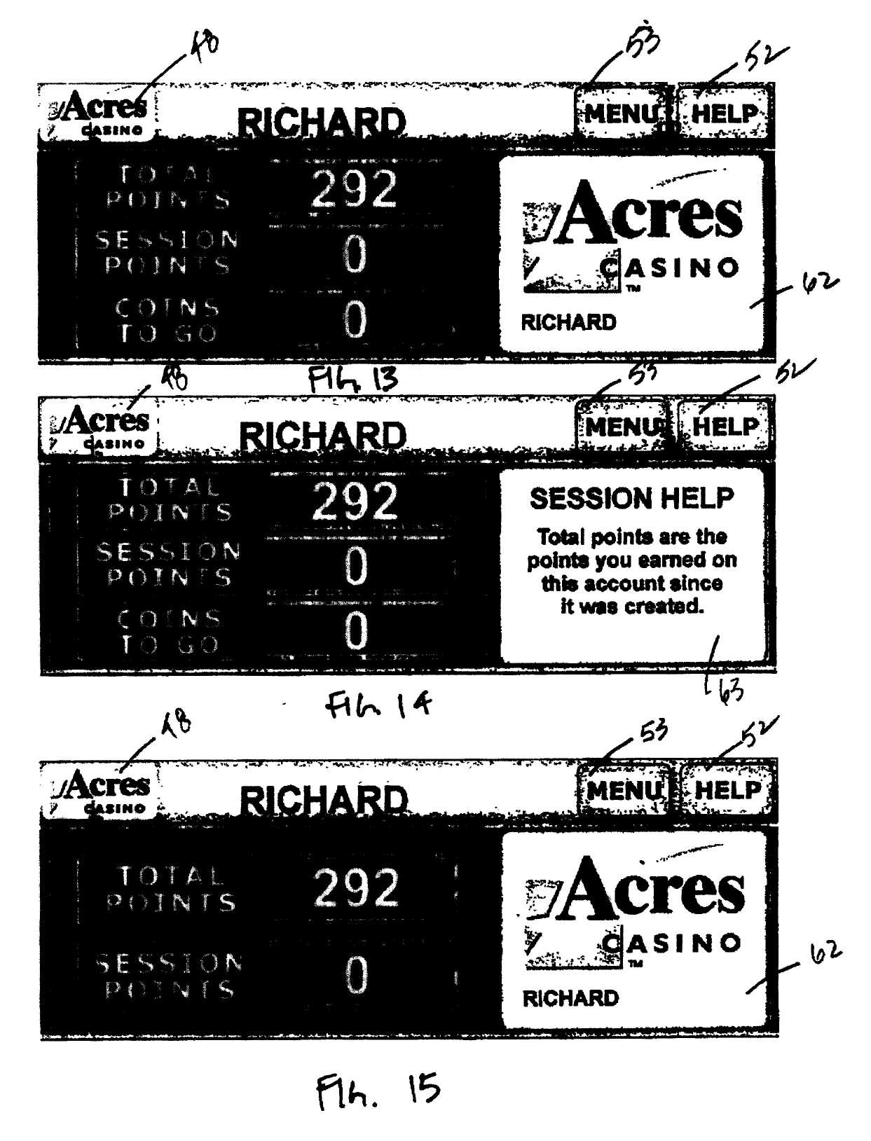

FIG. 15 is another version of the FIG. 13 session screen. The FIG. 15 image does not include the Coins to Go field as a result of a configuration command entered by the casino operator on the Content Manager.

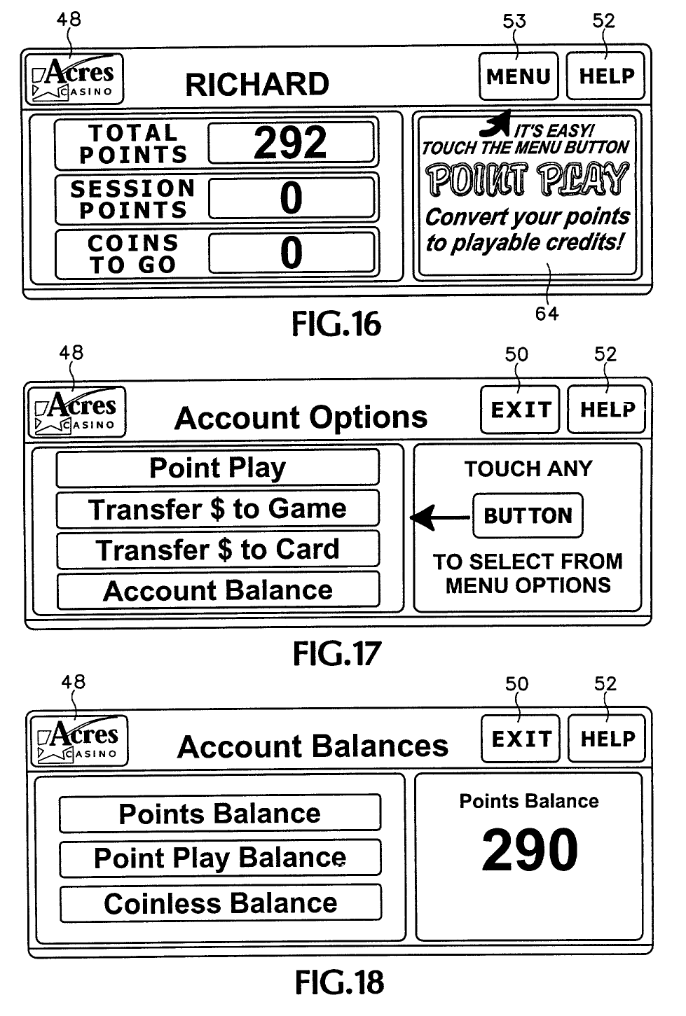

FIG. 16 is still another implementation of the session screen of FIGS. 13 and 15, which includes a session-attract area 64. When the session-attract feature is implemented, area 64 is configurable to display up to 32 screens in any sequence. When the sequence ends, it repeats in round-robin fashion. Each displayable screen has a programmable duration, time of day control, and sound controls, all of which are programmable by the operator using the Content Manager. The session-attract area may also be used to notify players of special events and awards.

FIG. 17 depicts a menu-mode screen, which is initiated when the player touches Menu button 53. Menu screens contain two touch screen buttons in the upper right-hand comer, namely Exit button 50 and Help button 52. As previously mentioned, the Exit button allows the player to cancel current operations or move back to the previous screen. Any of the four buttons on the left are pushed to select different menu options.

For example, touching the Account Balance button in FIG. 17 produces the menu display screen of FIG. 18. Pushing each of the buttons on the left of FIG. 18 provides the corresponding balance on the right of the screen. The Points Balance button provides the balance of player tracking points. Touching the Point Play Balance button shows the value of machine credits that have been converted by the player at the gaming machine from player tracking points. These credits are referred to by applicant as Xtra Credit points and are described in applicant's co-pending '065 application.

The Coinless Balance button in FIG. 18 provides a balance for a player's cashless play account as described in applicant's co-pending '598 application.

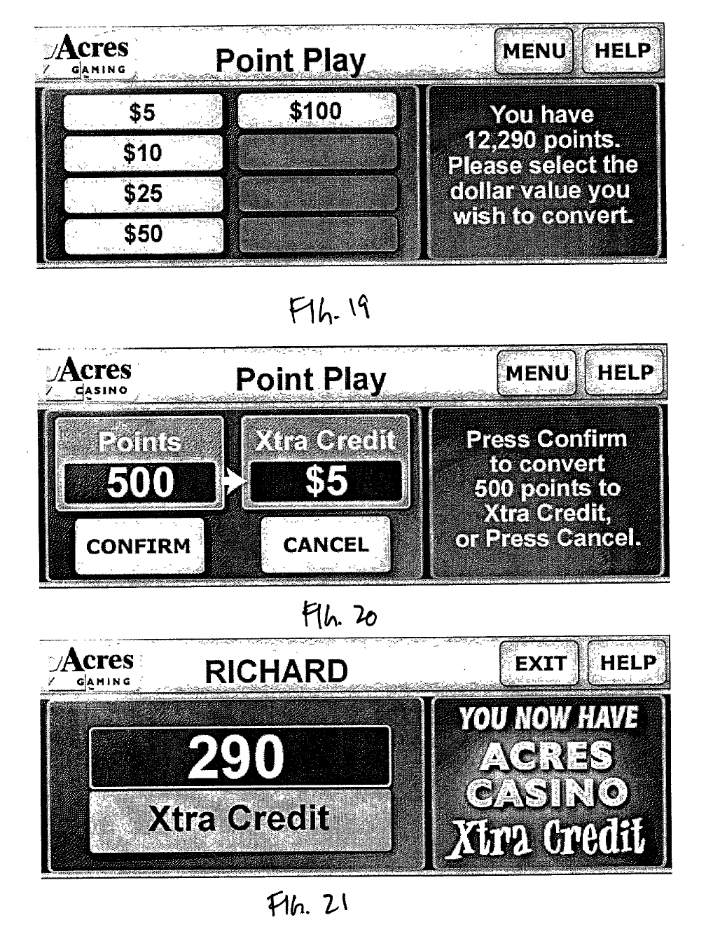

Returning again to FIG. 17, when Point Play button is touched, the image of FIG. 19 appears on the screen. This is the feature that allows players to convert their point balances into game playable credits (Xtra Credit). On the image of FIG. 19, the player selects one of the dollar amounts of credits that he or she wishes to exchange for points in the player's account. Touching, e.g., the $5 button in FIG. 19 produces the Point Play image of FIG. 20. Touching the Confirm button in FIG. 20 moves $5.00 of Xtra Credit to the player's Xtra Credit account, designated “Point Play Balance” in FIG. 18.

Turning now to FIG. 21, an Xtra Credit display replaces the Welcome display of FIG. 12 when a player has Xtra Credit. The player then plays off any Xtra Credit, and—after doing so—the session screen, like, e.g., the session screen of FIG. 13, is displayed.

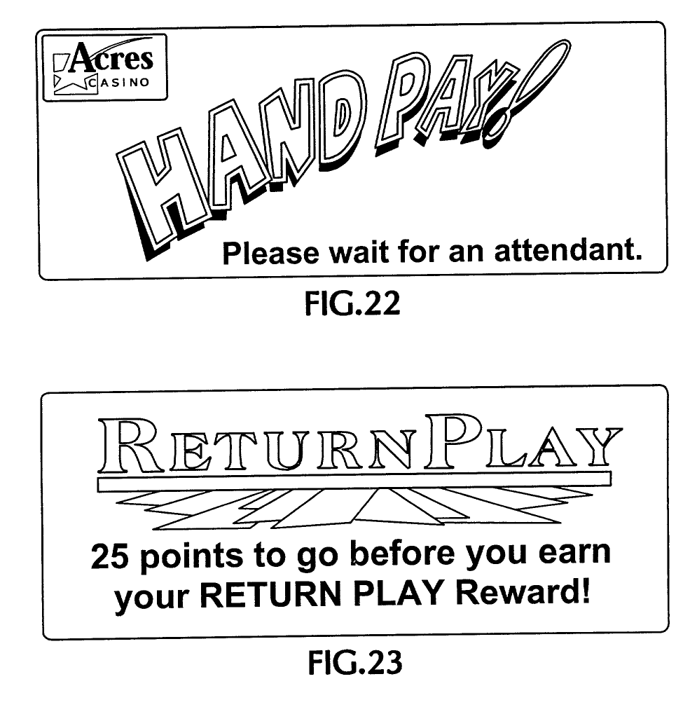

FIG. 22 illustrates a Hand Pay display, which appears whenever the slot machine is in a hand pay condition. This typically occurs for large jackpots or bonus awards that are too large to apply to the machine's credit meter. This display persists until the hand pay condition is cleared from the slot machine, typically by an attendant who arrives to clear the machine in a known manner.

FIG. 23 depicts a Return Play screen which is associated with the return play bonus, described in the '961 patent. Briefly, upon earning a pre-determined number of points in a session, the player is awarded gaming credits that cannot be played until after a predetermined later time. This induces the player to return to the casino to play off his or her credits.

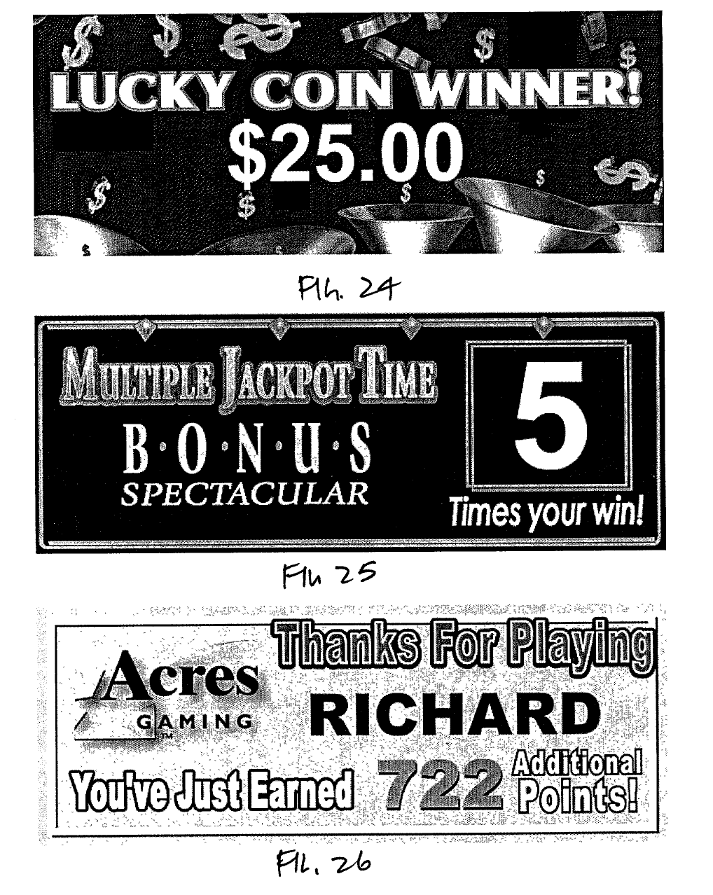

FIG. 24 depicts a screen that appears when the player is a winner of the Lucky Coin bonus, a random award that is described in applicant's U.S. Pat. No. 6,375,569, issued Apr. 23, 2002.

FIG. 25 informs the player that the multiple jackpot bonus is in effect, a bonus promotion described in the '961 patent.

Upon withdrawal of the player's card, the image of FIG. 26 is displayed. The image persists on the screen for a period of up to 10 seconds, which can be designated by the operator on the Content Manager.

In another aspect of the present invention, the display can be used to implement what are sometimes referred to as secondary or top-box games. For example, U.S. Patent Application Serial No. 60/282,703 discloses a secondary game that includes a display mounted on the top of a commercially available slot machine. The same secondary game can be implemented via software stored on board 38. This software can drive display 16 in the same fashion as the upper portion of the game described in the '703 application. A percentage of each coin played in a session can be allocated to a pool personal to the player. This pool can fund an award resulting in playing the secondary game implemented on display 16. The sound associated with that secondary game is played via speakers 42, 44.

In addition, a subset of slot machines on the casino network can be grouped to provide a secondary game in which multiple players participated as shown in U.S. patent application Ser. No. 09/104,145, which is assigned to the assignee of the present application and which is incorporated herein by reference for all purposes. Software implementing that game can be used to cause the display 16 on each of the grouped machines to depict substantially the same graphics associated with the secondary game screen as shown in the '145 application.

Finally, a subset of the slot machines or the entire network could be selected for periodic bonus games that utilize display 16.

1. A method for operating networked gaming devices comprising:
permitting a player to play one of the gaming devices;
providing services to the player via the network, such services being related to play on the gaming device;
communicating information to the player about the network services via a touch screen display associated with the gaming device; and
accepting a communication from the player via the touch screen display.

2. The method of claim 1 wherein said services comprise crediting the player with a bonus award and wherein said information relates to the bonus award.

3. The method of claim 2 wherein said method further comprises displaying information about the award on said display.

4. The method of claim 2 wherein accepting a communication from the player via the touch screen display comprises accepting a communication relating to the bonus award.

5. The method of claim 1 wherein said services comprise player tracking services and wherein said information relates to player tracking.

6. The method of claim 5 wherein said method further comprises displaying information about player tracking on said display.

7. The method of claim 5 wherein accepting a communication from the player via the touch screen display comprises accepting a communication relating to player tracking.

8. The method of claim 5 wherein said information comprises accrued playertracking points.

9. The method of claim 8 wherein accepting a communication from the player via the touch screen display comprises accepting a communication that converts the points to credits.

10. The method of claim 1 wherein said services comprise cashless-play services and wherein said information relates to cashless play.

11. The method of claim 10 wherein said method further comprises displaying information about cashless play on said display.

12. The method of claim 10 wherein accepting a communication from the player via the touch screen display comprises accepting a communication relating to cashless play.

13. The method of claim 10 wherein said information comprises an account balance.

14. The method of claim 13 wherein accepting a communication from the player via the touch screen display comprises accepting a communication that applies at least a portion of the account balance to the gaming device.

15. The method of claim 1 wherein said services comprise providing a secondary game to the player and wherein said information relates to the secondary game.

16. The method of claim 15 wherein said method further comprises displaying information about the secondary game on said display.

17. The method of claim 15 wherein accepting a communication from the player via the touch screen display comprises accepting a communication relating to the secondary game.

18. The method of claim 15 wherein said information comprises information about the secondary game.

19. The method of claim 1 wherein said method further includes generating a video image on said display.

20. The method of claim 19 wherein said method further includes providing said video image to said display via a second network.

21. The method of claim 1 wherein a speaker is associated with at least one of the displays and wherein said method further includes generating an audio output on said speaker.

22. The method of claim 21 wherein said method further includes providing an audio signal to said speaker via a second network.

23. The method of claim 1 wherein said method further includes providing at least one help image on said display for providing information about the touch screen display.

24. The method of claim 23 wherein said at least one image is provided responsive to a communication from the player via the touch screen display.

25. Apparatus for communicating with a player of a gaming device on a network of gaming devices, said apparatus comprising:
a display associated with the networked gaming device, said display being operatively connected to the gaming device network;
a computer operatively connected to the network, said computer generating information about services provided to the player;
a circuit associated with the display for creating images on the display responsive to such information; and
a touch screen associated with said display for accepting communications from the player.

26. The apparatus of claim 25 wherein said touch screen is operatively connected to said network for communicating with networked components.

27. The apparatus of claim 25 wherein said apparatus further comprises a communications circuit for enabling communications between said touch screen and said network.

28. The apparatus of claim 25 wherein said computer is programmed to operate a secondary game responsive to touch screen communication from the player.

29. The apparatus of claim 28 wherein said secondary game includes images generated on said display responsive to network communication from said computer.

30. The apparatus of claim 25 wherein said display further includes a video input for generating animated images on said display.

31. The apparatus of claim 30 wherein said apparatus further includes a second network operatively connected to said display for delivering video signals to said video input.

32. The apparatus of claim 25 wherein said computer is programmed to implement a cashless-play feature responsive to touch screen communication from the player.

33. The apparatus of claim 32 wherein said cashless-play feature includes images generated on said display responsive to network communication from said computer.

34. The apparatus of claim 25 wherein said computer is programmed to implement a player-tracking feature responsive to touch screen communication from the player.

35. The apparatus of claim 32 wherein said player-tracking feature includes images generated on said display responsive to network communication from said computer.

36. The apparatus of claim 25 wherein said computer is programmed to award bonuses to at least one player of the networked gaming devices.

37. The apparatus of claim 36 wherein said computer is programmed to generate images on said display related to a bonus award.

38. The apparatus of claim 25 wherein said apparatus further includes a circuit constructed to display at least one help image on the display for providing information about the touch screen display.

39. The apparatus of claim 38 wherein said apparatus is constructed and arranged to provide said at least one image responsive to a communication from the player via the touch screen display.

40. Apparatus for communicating between a player of a networked gaming device and the network to which said gaming device is connected, said apparatus comprising:
a display connectable to such a network;
a circuit associated with said display for creating images on the display responsive to communication on the network when said display is so connected; and
a touch screen associated with said display for accepting communication from the player.

41. The apparatus of claim 40 wherein said apparatus further comprises a communications circuit for enabling communications between said touch screen and said network.

42. The apparatus of claim 40 wherein said display further includes a video input for generating animated images on said display.

43. The apparatus of claim 40 wherein said apparatus further includes a circuit constructed to display at least one help image on the display for providing information about the touch screen display.

44. The apparatus of claim 43 wherein said apparatus is constructed and arranged to provide said at least one image responsive to a communication from the player via the touch screen.
